(19) United States
(12) Patent Application Publication
(10) Pub. No.: US 2004/0169895 A1
(43) Pub. Date: Sep. 2, 2004

(54) Image reading apparatus

(75) Inventors: Yusuke Hashizume, Urayasu-shi (JP); Sueo Ueno, Mishima-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/787,077

(22) Filed: Feb. 27, 2004

(30) Foreign Application Priority Data
Feb. 28, 2003 (JP) 2003-054321
Mar. 3, 2003 (JP) 2003-056163
Nov. 18, 2003 (JP) 2003-388012

(51) Int. Cl. H04N 9/07; H04N 1/46

(52) U.S. Cl. 358/474; 358/500; 358/461

(57) ABSTRACT

An image reading apparatus has a photoelectric converting unit composed of a color line sensor and a monochromatic line sensor. In a color read mode, the image reading apparatus starts reading a document image at a color read start position. In a monochromatic read mode, the image reading apparatus starts reading a document image at a monochromatic read start position.

### CROSS-REFERENCE TO RELATED APPLICATIONS

This application is based upon and claims the benefit of priority from prior Japanese Patent Applications No. 2003-054321, filed Feb. 28, 2003; No. 2003-056163, filed Mar. 3, 2003; and No. 2003-388012, filed Nov. 18, 2003, the entire contents of all of which are incorporated herein by reference.

### BACKGROUND OF THE INVENTION

1. Field of the Invention

The present invention relates to, for example, an image reading apparatus that optically scans an image on a document to read the image from the document in multiple colors or monochromatically in accordance with a read mode selected by a user.

2. Description of the Related Art

With a conventional image reading apparatus (color image reading apparatus) that reads an image from a document in multiple colors, a color image is read with a color CCD sensor by moving a carriage to optically scan the entire document. The conventional color image reading apparatus uses, as a color CCD sensor, a 3-line CCD sensor composed of three CCD line sensors including a first CCD line sensor that outputs a red component (R signal), a second CCD line sensor that outputs a green component (G signal), and a third CCD line sensor that outputs a blue component (B signal).

With an image reading apparatus in which the above conventional 3-line CCD sensor is mounted, if a monochromatic image is read, it is generated on the basis of a signal (RGB signal) outputted by the three CCD sensors. Thus, with the conventional color image reading apparatus, whether or not an image is read from a document in multiple colors or monochromatically, image data is obtained with the 3-line CCD sensor by moving the carriage from a predetermined read start position to optically scan the entire document.

Furthermore, with the image reading apparatus in which the conventional 3-line CCD sensor is mounted, if an image is read from a document being conveyed by an automatic document feeder (ADF), a read position is set so that the center of three scan positions corresponding to the three CCD line sensors coincides with an optimum scan position. Specifically, with the image reading apparatus in which the conventional 3-line CCD sensor is mounted, the same line sensors are used to read an image either in a color read mode or in a monochromatic read mode. Thus, with the image reading apparatus in which the conventional 3-line CCD sensor is mounted, if an image is read using the ADF, the read position where the scan position of each of the line sensors is optimum is the same both in the color read mode and in the monochromatic read mode.

### BRIEF SUMMARY OF THE INVENTION

It is an object of the present invention to provide an image reading apparatus which can efficiently read a favorable image to achieve high-quality image reading whether the image is in multiple colors or monochromatic.

An image reading apparatus according to the present invention reads an image from a document placed on a document glass, in multiple colors or monochromatically, and has a photoelectric converting unit composed of a color line sensor and a monochromatic line sensor, a scanning section in which an optical system guiding light from the document on the document glass to the photoelectric converting unit is mounted, a driving mechanism which moves the scanning section in a sub-scanning direction relative to the document on the document glass, and a control section which uses the color line sensor to start loading image data if the image is read, in multiple colors, from the document placed on the document glass and when a scan position of the scanning section moved by the driving mechanism in the sub-scanning direction reaches a color read start position, and which uses the monochromatic line sensor to start loading image data if the image is read monochromatically from the document placed on the document glass and when the scan position of the scanning section moved by the driving mechanism in the sub-scanning direction reaches a monochromatic read start position different from the color read start position.

An image reading apparatus according to the present invention reads an image from a document in multiple colors or monochromatically, and has a document feeding section which conveys the document placed on a document feeding table, a photoelectric converting unit composed of a color line sensor and a monochromatic line sensor, a scanning section in which an optical system guiding light from the document conveyed from the document feeding section to the photoelectric converting unit is mounted, a driving mechanism which moves the scanning section, and a control section which uses the driving mechanism to move the scanning section from a predetermined standby position to a color read position if the image is read from the document conveyed by the document feeding section in a color read mode in which the color line sensor reads the image, the control section using the driving mechanism to move the scanning section from the predetermined standby position to a monochromatic read position if the image is read from the document conveyed by the document feeding section in a monochromatic read mode in which the monochromatic line sensor reads the image.

An image reading apparatus according to the present invention reads an image from a document in multiple colors or monochromatically, and has a document feeding section which conveys the document placed on a document feeding table, a photoelectric converting unit composed of a color line sensor and a monochromatic line sensor, a scanning section in which an optical system guiding light from a read surface of the document conveyed from the document feeding section to each line sensor of the photoelectric converting section is mounted, a driving mechanism which moves the scanning section, and a control section which uses the driving mechanism to move the scanning section from a predetermined standby position to a read position set on the basis of an location of each line sensor with respect to the read surface of the document conveyed by the document feeding section as well as a sensitivity of each line sensor if the image is read from the document conveyed by the document feeding section, in multiple colors or monochromatically.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a diagram showing the configuration of a 4-line CCD sensor mounted in an image reading apparatus according to each embodiment of the present invention;

FIG. 2 is a diagram schematically showing the configuration of an image reading apparatus according to a first embodiment;

FIG. 3 is a block diagram showing an example of the configuration of a control system of the image reading apparatus;

FIG. 4 is a diagram illustrating a read start position for a color image according to the image reading apparatus of the first embodiment;

FIG. 5 is a diagram illustrating a read start position for a monochromatic image according to the image reading apparatus of the first embodiment;

FIG. 6 is a timing chart showing the relationship between a driving clock and a read timing according to the image reading apparatus of the first embodiment;

FIG. 7 is a flow chart illustrating an example of an operation of the image reading apparatus of the first embodiment;

FIG. 8 is a diagram schematically showing the configuration of an image reading apparatus according to a second and third embodiments of the present invention;

FIG. 9 is a diagram illustrating the relationship between a read surface of a document conveyed by an ADF and a focus;

FIG. 10 is a diagram showing foci based on scan positions of the line sensors other than a blue one if the scan position of the blue line sensor is set as a focused position;

FIG. 11 is a diagram showing a read position in a color read mode according to the second embodiment;

FIG. 12 is a diagram showing a read position in the color read mode according to the second embodiment;

FIG. 13 is a diagram showing a read position in a monochromatic read mode according to the second embodiment;

FIG. 14 is a diagram showing a read position in the monochromatic read mode according to the second embodiment;

FIG. 15 is a flow chart illustrating operations performed on an image on a document using the ADF according to the second embodiment;

FIG. 16 is a graph showing the characteristics of sensitivities of the red, green, and blue sensors;

FIG. 17 is a graph showing the characteristic of sensitivity of a monochromatic line sensor;

FIG. 18 is a diagram showing an example of the relationship between a scan position and a focal length;

FIG. 19 is a diagram showing an example of the relationship between the scan position and the focal length;

FIG. 20 is a diagram showing an example of the relationship between the scan position and the focal length; and

FIG. 21 is a flow chart illustrating operations performed on an image on a document using the ADF according to the third embodiment.

### DETAILED DESCRIPTION OF THE INVENTION

A first, second, and third embodiments of the present invention will be described below with reference to the drawings.

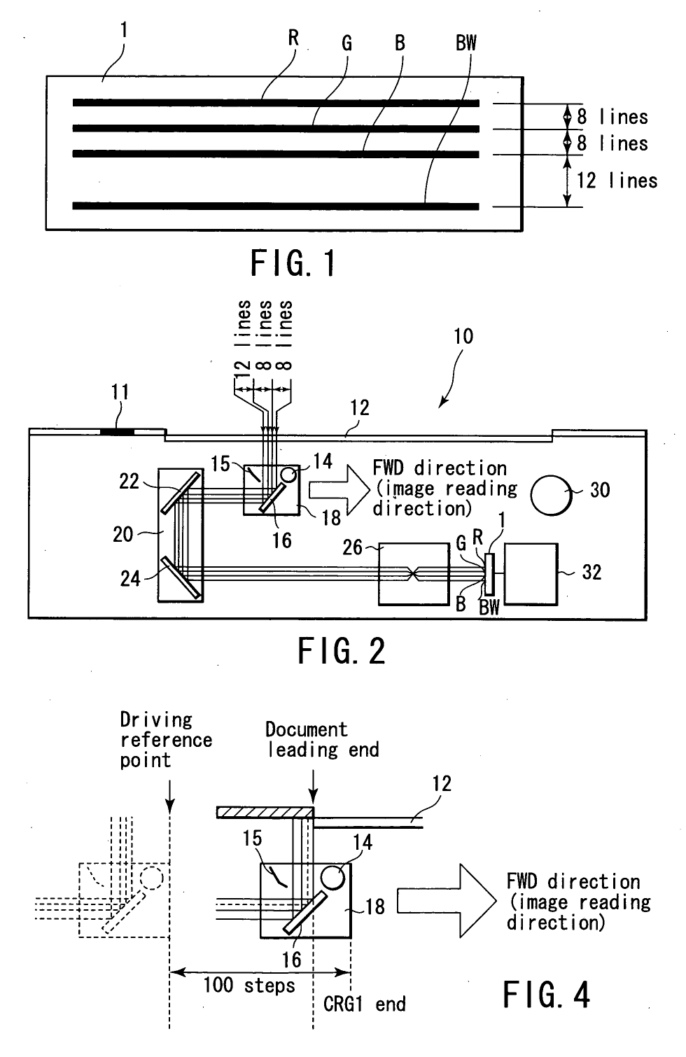

FIG. 1 is a diagram showing an example of the configuration of a 4-line CCD sensor 1 mounted in an image reading apparatus according to the first, second, and third embodiments of the present invention and operating as a photoelectric converting unit.

As shown in FIG. 1, the 4-line CCD sensor 1 is composed of a red line sensor R that photoelectrically converts a red component of incident light into an R signal indicative of the density of red, a green line sensor G that photoelectrically converts a green component of the incident light into a G signal indicative of the density of green, a blue line sensor B that photoelectrically converts a blue component of the incident light into a B signal indicative of the density of blue, and a black and white line sensor BW that photoelectrically converts a black and white component of the incident light into a BW signal indicative of the density of black and white.

In the 4-line CCD sensor (photoelectric converting unit) 1, the red line sensor R, the green line sensor G, and the blue line sensor B constitute a color line sensor that reads an image in multiple colors. Furthermore, in the 4-line CCD sensor 1, the black and white line sensor BW constitutes a monochromatic color sensor that monochromatically reads an image.

The red line sensor is composed of a CCD line sensor including a red filter. Thus, the red line sensor R can load only the red component of the incident light to output the R signal.

The green line sensor is composed of a CCD line sensor including a green filter. Thus, the green line sensor G can load only the green component of the incident light to output the G signal.

The blue line sensor is composed of a CCD line sensor including a blue filter. Thus, the blue line sensor R can load only the blue component of the incident light to output the B signal.

In the 4-line CCD sensor 1, the line sensors R, G, B, and BW are arranged parallel with one another at predetermined intervals. In the example shown in FIG. 1, the line sensors are arranged in order of R, G, B, and BW. The interval between the red line sensor R and the green line sensor G and the interval between the green line sensor G and the blue line sensor B are each 8 lines. The interval between the blue line sensor B and the black and white line sensor BW is 12 lines.

Specifically, the red line sensor R, the green line sensor G, and the blue line sensor B, which constitute the color line sensor, are arranged parallel with one another at intervals of 8 lines. The black and white line sensor BW as the monochromatic line sensor is placed parallel with the blue line sensor B and 12 lines away from it. Here, the interline distance (width) on a document is, for example, 0.042333 mm at a read resolution of 600 dpi.

First, the first embodiment will be described.

FIG. 2 is a diagram showing an example of the configuration of an image reading apparatus 10 according to the first embodiment of the present invention. The 4-line CCD sensor 1 such as the one shown in FIG. 1 is mounted in the image reading apparatus 10, shown in FIG. 2.

As shown in FIG. 2, the image reading apparatus 10 has the 4-line CCD sensor 1, a document glass 12, an exposure lamp 14, a reflector 15, a first mirror 16, a first carriage (scanning section) 18, a second carriage 20, a second mirror 22, a third mirror 24, an image forming lens 26, a driving motor (driving mechanism) 30, a control unit (control section) 30, and others.

The document glass 12 is composed of a colorless, transparent member such as glass which allows light to pass through. A document cover (not shown) is provided on the document glass 12. The document cover (not shown) presses a document on the document glass 12 against the glass surface used as the document glass 12.

The exposure lamp 14 functions as a light source that lights the document placed on the document glass 12. The reflector 15 reflects part of light from the exposure lamp 14 to light the document D. The first mirror 16 polarizes the reflected light from a shading correcting plate 11 or the document D in a predetermined direction.

The exposure lamp 14, the reflector 15, the first mirror 16, and others are mounted on the first carriage 18. The first carriage 18 is located below the document glass 12 so as to move parallel with the document glass 12. The first carriage 18 is reciprocated by the driving motor 30 below the document glass 12, the driving motor 30 being connected to the first carriage 18 via a toothed belt or the like (not shown). The driving motor 30 is composed of a stepping motor or the like which is drivingly controlled by a driving pulse signal or the like from the control unit 30.

Moreover, the second carriage 20 is disposed below the document glass 12 so as to move parallel with the document glass 12. A second mirror 22 and a third mirror 24 are attached to the second carriage 20 at right angles to sequentially polarize the reflected light from the document D which light has been polarized by the first mirror 16. A driving force from the driving motor 30 is transmitted to the second carriage 20 by the toothed belt or the like which drives the first carriage 18. The second carriage 20 follows the first carriage 18. The second carriage 20 moves along the document glass 12 at a speed half that of the first carriage 18.

An image forming lens 26 and the 4-line CCD sensor 1 are disposed below the document glass 12; the image forming lens 26 focuses the reflected light from the third mirror 24, mounted on the second carriage 20, and the 4-line CCD sensor 1 receives and photoelectrically converts the reflected light focused by the image forming lens 26. The image forming lens 26 is disposed in a plane containing the optical axis of the light polarized by the third mirror 24, so as to be moved via a driving mechanism (not shown). The image forming lens 26 moves to form the reflected light into an image using a desired scale factor. Then, in the 4-line CCD sensor 1, the line sensors R, G, B, and Bw photo-electrically convert the light incident via the image forming lens 26 for each pixel. The 4-line sensor 1 then outputs the converted light to the control unit 32.

Now, description will be given of the configuration of a control system of the image reading apparatus 10.

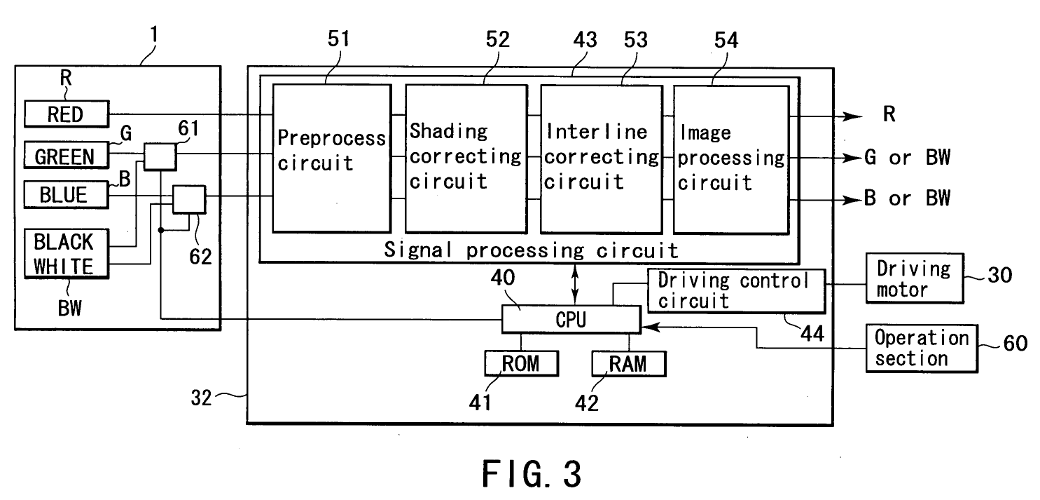

FIG. 3 is a block diagram schematically showing the configuration of the control system of the image reading apparatus 10.

A CPU 40, a ROM 41, a RAM 42, a signal processing section 43, a driving control section 44, and others are provided on a control circuit board 32 of the image reading apparatus 10. The CPU 40 connects to an operation section 60 to which operational instructions from a user are inputted, and switching circuits 61 and 62.

The CPU 40 controls the whole image reading apparatus 10. The ROM 41 is a memory that stores, for example, a control program required to perform the image reading operation. The RAM 42 is a memory that temporarily stores data. The signal processing section 43 processes signals from the 4-line CCD sensor 1 and outputs the processed signals to external equipment. The driving control section 44 has a motor driver that drivingly controls the driving motor 30.

The signal processing section 43 has a preprocess circuit 51, a shading correcting circuit 52, an interline correcting circuit 53, and an image processing circuit 54.

The preprocess circuit 51 executes a preprocess of amplifying an analog signal from the 4-line CCD sensor 1 and converting it into digital signals. The shading correcting circuit 52 executes a process of correcting an output signal from each line sensor R, G, B, or BW for each pixel on the basis of the results of reading of a shading plate (not shown).

The interline correcting circuit 53 aligns the R signal from the red line sensor R, the G signal from the green line sensor G, and the B signal from the blue line sensor B with one another. Specifically, the line sensors R, G, and B, which constitute the color line sensor, are arranged offset from one another by several pixels. Thus, to generate a color image, it is necessary to match the phases of the signals (R, G, and B signals) from the line sensors R, G, and B to one another in accordance with the moving speed in the sub-scanning direction.

For example, in the example of configuration shown in FIG. 1, the red, green, and blue line sensors R, G, and B, which constitute the color line sensor, are arranged in order of R, G, and B so that they can carry out scans in this order. The red line sensor R and the green line sensor G are offset from each other by 8 pixels. The green line sensor G and the blue line sensor B are offset from each other by 8 pixels. In this case, if a variable power ratio is 25% to 400%, then for data from the line sensors R, G, and B, the pair of line sensors R and G must have their positions corrected by 2 to 32 lines. The pair of line sensors G and B must also have their positions corrected by 2 to 32 lines.

Here, if for example, the blue line sensor B is set as a reference, the interline correcting circuit 53 shifts the R signal from the red line sensor R by 4 to 64 lines for alignment. The interline correcting circuit 53 shifts the G signal from the green line sensor G by 2 to 32 lines for alignment. The interline correcting circuit 53 executes such alignment to superimpose the data in the R, G, and B signals on one another to generate an integral color image.

The image processing circuit 54 executes image processing and outputs image to external equipment. For example, in a color read mode in which a document image is read in multiple colors, the image processing circuit 54 executes color corrections on the data subjected by the interline correcting circuit 53 to interline corrections. The image processing circuit 54 then outputs the corrected data to the external equipment. On the other hand, in a monochromatic read mode in which an image is monochromatically read from a document, the image processing circuit 54 executes a filter process on data passed through the interline correcting circuit 53, that is, the BW signal. The image processing circuit 54 then outputs the processed data to the external equipment.

The CPU 40 also connects to the operation section 60, to which operational instructions from the user are inputted. The operation section 60 is provided with, for example, a setting key that sets a read scale factor, an image selection key that selects either the color read mode, in which an image is read in multiple colors, or the monochromatic read mode, in which an image is monochromatically read, an instruction key that instructs on the start of reading, and other keys. If for example, the user enters, from the operation section 60, a key which specifies the read mode for a document and which instructs on the start of reading, the CPU 40 starts reading the image from the document in the specified read mode.

Moreover, the CPU 40 connects to the switching circuits 61 and 62. The switching circuit 61 switches between the G signal from the green line sensor G and the BW signal from the black and white line sensor BW; both signals are included in the signals supplied by the 4-line CCD sensor 1 to the signal processing circuit 43. The switching circuit 62 switches between the B signal from the blue line sensor B and the BW signal from the black and white line sensor BW; both signals are included in the signals supplied by the 4-line CCD sensor 1 to the signal processing circuit 43.

In the color read mode, the CPU 40 causes the switching circuit 61 to enable the G signal, while causing the switching circuit 62 to enable the B signal. In this case, the 4-line CCD sensor 1 supplies the signal processing circuit 43 with the R signal from the red line sensor R, the G signal from the green line sensor G, and the B signal from the blue line sensor B. This enables the 4-line CCD sensor 1 to read a color image.

On the other hand, in the monochromatic read mode, the CPU 40 causes the switching circuit 61 to enable the BW signal, while causing the switching circuit 62 to enable the BW signal. In this case, the 4-line CCD sensor 1 supplies the signal processing circuit 43 with the BW signal from the black and white line sensor BW. This enables the 4-line CCD sensor 1 to read a monochromatic image. If a monochromatic image is read using the arrangement shown in FIG. 3, the 4-line CCD sensor 1 supplies the signal processing circuit 43 with BW signals through two channels. In this case, one of the channels provides a BW signal for the even-number lines, whereas the other provides a BW signal for the odd-number lines.

Now, description will be given of a read start position for a document according to the image reading apparatus 10.

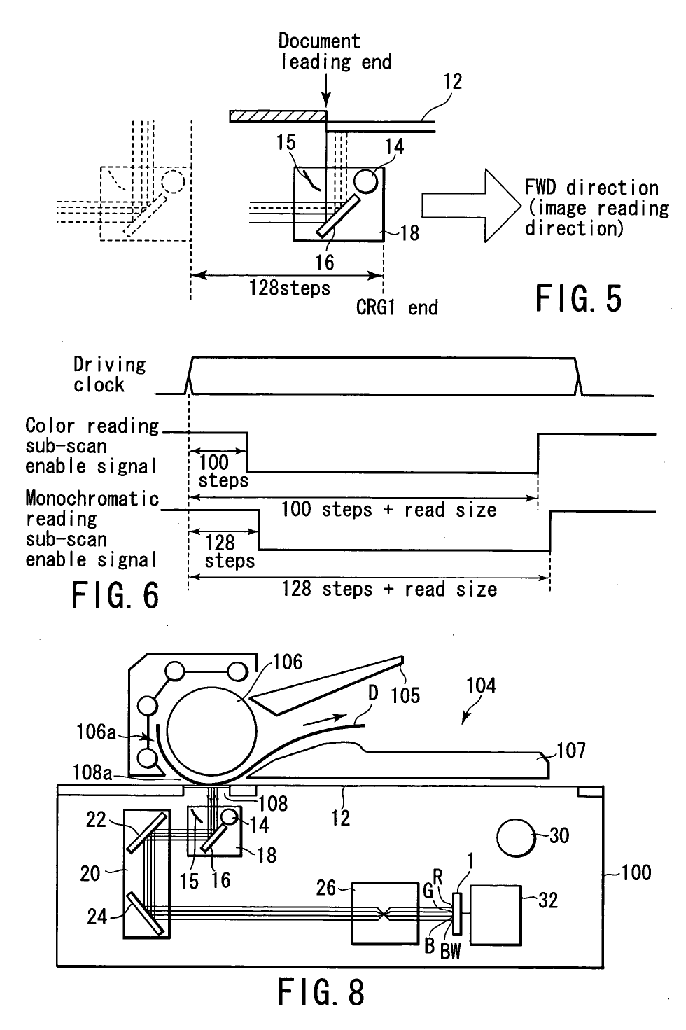

FIGS. 4 and 5 are diagrams illustrating the read start position of the first carriage 18.

As shown in FIGS. 4 and 5, the first carriage 18 stands by at a predetermined standby position (at this time, a leading end portion of the first carriage 18 is set as a driving reference point in an image reading direction). In this state, when a request is made to start reading an image, the CPU 44 causes the driving control section 44 to supply a driving clock to the driving motor 30 to move the first carriage 18 in the image reading direction (sub-scanning direction) from the standby position.

The CPU 40 moves the first carriage 18 from the standby position so that a desired reading speed is obtained when at least the first carriage 18 reaches a leading end position of the document. That is, the standby position (driving reference point) of the first carriage 18 is set so that at the reading start position, the first carriage 18 can be moved at a predetermined speed in the sub-scanning direction.

In this description, the first carriage 18 moves a distance equal to one line (one pixel in the sub-scanning direction) during one step of the driving clock.

First, description will be given of the image read position in the color read mode.

FIG. 4 is a diagram showing a read start position used if the image reading apparatus 10 reads an image from a document in multiple colors.

In this description, the read position (scan position) of the red line sensor R corresponds to the position of the first carriage established after advancing 100 steps from the standby position, at which position the first carriage reaches the leading end position of the document, as shown in FIG. 4.

As described above, a color image is read by the three line sensors of the 4-line CCD sensor 1, that is, the red line sensor R, the green line sensor G, and the blue line sensor B (the color line sensor). In the 4-line CCD sensor, the three line sensors R, G, and B, which constitute the color line sensor, are arranged at intervals of 8 lines in order of R, G, and B as shown in FIG. 1.

Thus, as shown in FIG. 4, the color read start position is where the read position of the red line sensor R coincides with the leading end portion of the document. Specifically, as shown in FIG. 4, it is assumed that when the first carriage advances 100 steps from the standby position, the read position of the red line sensor R coincides with the leading end portion of the document. Then, the color read start position corresponds to 100 steps (a color read start clock) from the standby position. In this case, the color read start clock reaches 100 steps.

Specifically, in the color read mode, when the driving clock to the driving motor 30 reaches 100 steps, the CPU 40 starts loading the R signal from the red line sensor. Then, the green line sensor G starts reading the G signal 8 lines after the R signal from the red line sensor R. The blue line sensor B starts reading the B signal 8 lines after the G signal from the red line sensor G (16 lines after the R signal from the red line sensor R).

That is, the color image on the document is read so that the line CCD sensors read the components of light guided by the optical systems mounted on the first and second carriages; these signals are read in order of R, G, and B at intervals of 8 lines. In the signal processing section 43, the interline correcting circuit 53 and others synthesize the R, G, and B signals and then output the synchronized signal as data on the color image.

Furthermore, the present image reading apparatus reads a read size of image starting with the leading end portion of the document. The number of steps in the driving clock which number corresponds to the read size may be determined on the basis of a size specified by the user using the operation section 60. Alternatively, it may be determined on the basis of a sensing size used by a document size sensing section (not shown). If a color image is read, the number of steps corresponding to the read size is the number of steps corresponding to an actual read size (a read size for one line sensor) plus 16 steps because the B signal from the blue line sensor B is read 16 lines later than the R signal from the red line sensor R.

Accordingly, a read end position (a color read end position) in the color read mode corresponds to the number of steps required to reach the read start position plus the number of steps corresponding to the read size (that is, a read end clock). When the image has been completely read, that is, when the driving clock reaches the number of steps corresponding to the read end position, then the CPU 40 ends moving the first carriage in the sub-scanning direction. The CPU 40 then returns the first carriage 18 to the standby position.

Now, the image read position in the monochromatic read mode will be described.

FIG. 5 is a diagram showing a read start position used if the image reading apparatus monochromatically reads an image from a document.

As described above, a monochromatic image is read by the black and white line sensor BW of the 4-line CCD sensor 1. On the 4-line CCD sensor 1, the black and white line sensor BW is 28 lines away from the red line sensor R (8 lines between the red line sensor R and the green line sensor G, 8 lines between the green line sensor R and the blue line sensor G, and 12 lines between the blue line sensor B and the black and white line sensor BW). Thus, if reading of the monochromatic image is started using the same timing as that used for the color image, the read position is offset by 28 lines.

Thus, at the position where the monochromatic image starts to be read (a monochromatic read start position), the read position of the black and white line sensor BW coincides with the leading end position of the document as shown in FIG. 5. If the first carriage is moving in the sub-scanning direction, the read position of the black and white line sensor BW is reached later than those of the other line sensors R, G, and B as shown in FIG. 5. This is based on the arrangement intervals among the line sensors R, G, B, and BW.

Here, it is assumed that after the first carriage 18 has advanced 100 steps from the standby position, the red line sensor R starts reading the leading end portion of the document. Then, the monochromatic read start position corresponds to 128 steps (a monochromatic read start clock). That is, the monochromatic read start clock corresponds to the number of steps (100) required to set the read position of the read line sensor R at the leading end portion of the document plus the number of steps (28) equal to the interval of 28 lines between the black and white line sensor BW and the red line sensor R.

Specifically, in the monochromatic read mode, when the driving clock to the driving motor 30 reaches 128 steps, the CPU 40 starts loading the BW signal from the black and white line sensor BW. Furthermore, in the monochromatic read mode, only the black and white line sensor BW carries out loading. Thus, a position where the monochromatic image ends to be read (a monochromatic read end position) corresponds to the number of steps (for example, 128) required to reach the monochromatic read start position plus the number of steps corresponding to the read size.

Now, description will be given of the relationship between the driving clock and read and a read timing for a document image.

FIG. 6 is a timing chart showing the relationship between an image read timing for the driving clock in the color read mode of the image reading apparatus 10 and an image read timing for the driving clock in the monochromatic read mode of the image reading apparatus 10.

When a request is made to start reading, the CPU 40 supplies the driving control section 44 with the driving clock, which drives the driving motor 30. The driving clock drives the driving motor 30 to move the first carriage 18 in the sub-scanning direction (image reading direction).

In the color read mode, for example, in the example shown in FIG. 4, when the driving clock reaches 100 steps (the color read start clock), the first carrier 18 reaches the color read start position. Accordingly, when the driving clock reaches 100 steps, the CPU 40 starts loading data (R, G, and B signals) from the color line sensor (red line sensor R, green line sensor G, and blue line sensor B).

When the driving clock reaches the number of steps (a color read end clock) equal to 100 steps plus the number of steps corresponding to the read size (color read size), the first carriage 18 reaches the color read end position. Accordingly, when the driving clock reaches the color read end clock, the CPU 40 ends loading data from the color line sensor. When the first carriage reaches the color read end position, the CPU 40 returns the first carriage 18 to the standby position.

In the monochromatic read mode, in the example shown in FIG. 5, when the driving clock reaches 128 steps (the monochromatic read start clock), the first carriage 18 reaches the monochromatic read start position. Accordingly, when the driving clock reaches 128 steps, the CPU 40 starts loading data (the BW signal) from the monochromatic line sensor (the black and white line sensor BW).

Furthermore, when the driving clock reaches the number of steps (a monochromatic read end clock) equal to 128 steps plus the number of steps corresponding to the read size (monochromatic read size), the first carriage 18 reaches the monochromatic read end position. Accordingly, when the driving clock reaches the monochromatic read end clock, the CPU 40 ends loading data from the monochromatic line sensor. When the first carriage 18 reaches the read end position, the CPU 40 returns the first carriage 18 to the standby position.

Now, description will be given of operations performed on a document image according to the first embodiment.

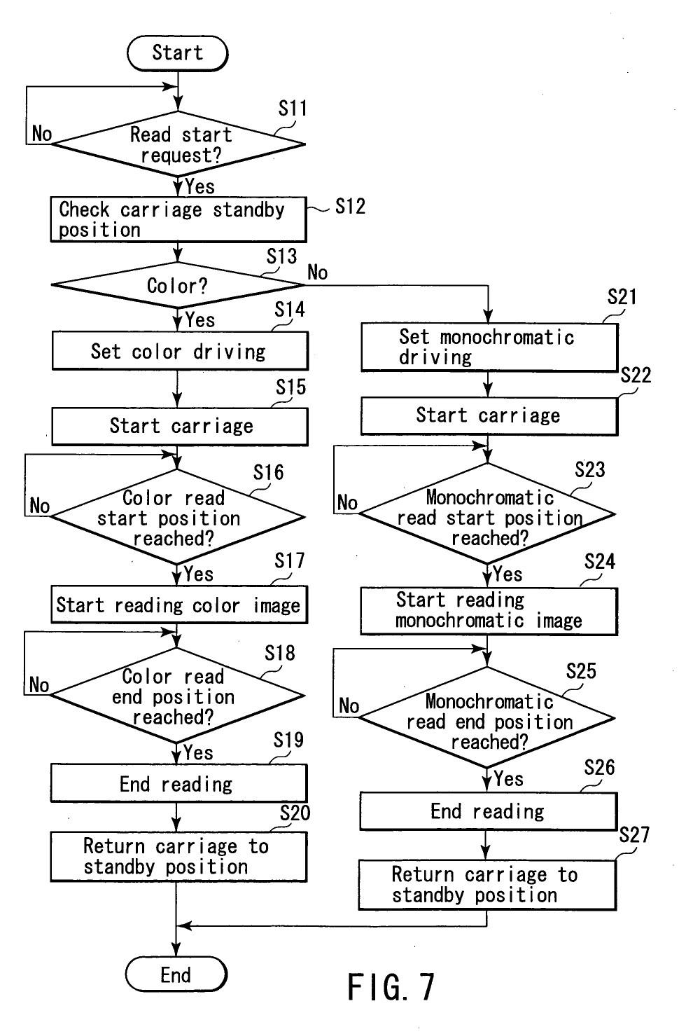

FIG. 7 is a flow chart illustrating an operation performed by the image reading apparatus to read a document image.

First, the user places a document on the document glass 12 and uses the operation section 60 to instruct on reading of a document image. On this occasion, the user selects the document read mode, that is, whether to read the image from the document in multiple colors (the color read mode) or monochromatically (the monochromatic read mode).

When the user instructs on the start of reading, the operation section 60 supplies the CPU 40 with a signal requesting the start of reading of the image from the document on the document glass 12 as well as information indicative of the document read mode.

Upon receiving the read start request from the operation section 60 (step S11), the CPU 40 checks whether or not the first carriage 18 is present at the standby position (step S12). Upon confirming that the first carriage 40 is at the standby position, the CPU 40 determines whether the document is to be read in the color read mode or the monochromatic read mode (step S13, YES).

If the CPU 40 determines that the document is to be read in the color read mode, it makes driving settings for the color read mode in accordance with read modes such as a read scale factor which have been specified by the user (step S14). For the driving settings for the color read mode, the CPU 40 sets the driving clock required to reach the color read start position and the driving clock required to reach the color read end position.

For example, if the color read start position is 100 steps away from the standby position, the driving clock for the read start position is set at 100 steps. The driving clock for the read end position is set at the number of steps equal to 100 steps plus the number of steps corresponding to the read size.

After making the driving settings for color reading, the CPU 40 causes the driving control section 44 to start driving the driving motor 30. Thus, the first carriage 18 starts moving in the sub-scanning direction (image reading direction) from the standby position (step S15). When the first carriage 18 reaches the color read start position, that is, when the driving clock, counted from the start of driving, reaches the number of steps for the read start position (step S16, YES), the CPU 40 starts loading the R, G, and B signals from the line sensors for colors R, G, and B. Thus, reading of the document image in multiple colors is started (step S17).

After starting to read the color image, the CPU 40 loads data from the line sensors for colors R, G, and B until the first carriage 18 reaches the color read end position.

Once the first carriage 18 reaches the color read end position, that is, once the driving clock, counted from the start of driving, reaches the number of steps corresponding to the color read end position, the CPU 40 ends loading data from the line sensors for colors R, G, and B. The CPU 40 ends the movement of the first carriage 18 and thus the reading of the color image (step S18). Upon ending the reading of the color image, the CPU 40 returns the first carriage 18 to the standby position (step S19) to finish the process.

On the other hand, if the CPU 40 determines in step S13 that the monochromatic read mode has been set, it makes driving settings for the monochromatic read mode in accordance with read modes such as the read scale factor which have been specified by the user (step S21). For the driving settings for the monochromatic read mode, the CPU 40 sets the driving clock required to reach the monochromatic read start position and the driving clock required to reach the monochromatic read end position.

For example, if the monochromatic read start position is 128 steps away from the standby position, the driving clock for the read start position is set at 128 steps. The driving clock for the read end position is set at the number of steps equal to 128 steps plus the number of steps corresponding to the read size.

After making the driving settings for monochromatic reading, the CPU 40 causes the driving control section 44 to start driving the driving motor 30. Thus, the first carriage 18 starts moving in the sub-scanning direction (image reading direction) from the standby position (step S22). When the first carriage 18 reaches the monochromatic read start position, that is, when the driving clock, counted from the start of driving, reaches the number of steps for the read start position (step S23, YES), the CPU 40 starts loading the BW signal from the monochromatic line sensor BW. Thus, monochromatic reading of the document image is started (step S24).

After starting to read the monochromatic image, the CPU 40 loads data from the black and white line sensors BW, which is the monochromatic line sensor, until the first carriage 18 reaches the monochromatic read end position.

Once the first carriage 18 reaches the monochromatic read end position, that is, once the driving clock, counted from the start of driving, reaches the number of steps corresponding to the monochromatic read end position (step S25, YES), the CPU 40 ends loading data from the monochromatic line sensor BW. The CPU 40 ends the movement of the first carriage 18 and thus the reading of the monochromatic image (step S26). Upon ending the reading of the monochromatic image, the CPU 40 returns the first carriage 18 to the standby position (step S27) to finish the process.

As described above, the image reading apparatus according to the first embodiment has the photoelectric converting unit, composed of the color line sensor and the monochromatic line sensor. If the document image is to be read in multiple colors, the image reading apparatus starts reading on the basis of the color read start position. If the document image is to be monochromatically read, the image reading apparatus starts reading on the basis of the monochromatic read start position.

Thus, the first embodiment ensures that the image can be read from the leading end of the document either in the color read mode or in the monochromatic read mode. This prevents the possible offset between a color image and a monochromatic image to enable a favorable image to be read regardless of the read mode.

Now, a second embodiment will be described.

FIG. 8 is a diagram showing an example of the configuration of an image reading apparatus according to the second embodiment.

The 4-line CCD sensor 1, shown in FIG. 1, is mounted in the image reading apparatus 100, shown in FIG. 8. The image reading apparatus 100, shown in FIG. 8, corresponds to the image reading apparatus 10 according to the first embodiment, shown in FIG. 2, which is provided with an ADF (Auto Document Feeder) 104.

As shown in FIG. 8, the main body of the image reading apparatus 100 is configured similarly to the main body of the image reading apparatus 10, shown in FIG. 2. Thus, the same arrangements of the image reading apparatus 100, shown in FIG. 8, as those of the image reading apparatus 10, shown in FIG. 2, are denoted by the same reference numerals. Their detailed descriptions are omitted. Furthermore, a control system of the image reading apparatus 100, shown in FIG. 8, is configured similarly to that of the image reading apparatus shown in FIG. 3. Its detailed description is omitted.

The ADF 104 is adapted to convey a plurality of sheets one by one to the read position and to function as a document presser for a document placed on the document glass 12.

As shown in FIG. 8, the ADF 104 has a document feeding table 105, a conveying section 106, and a document discharging table 107. Documents are placed on the document feeding table 105. The conveying section 106 takes the documents out of the document feeding table 105 one by one and then conveys them along a conveying path 106a. The document conveyed by the conveying section 106 along the conveying path 106a is discharged to the document discharging table 107. A slit portion 108 is formed in an image reading apparatus 100 main body side of the conveying path 106a. A contact glass 108a is provided in the slit portion 108.

Now, a brief description will be given of an operation of reading a document using the ADF 104.

First, document D set on the document feeding table 105 is conveyed by the conveying section 106 along the conveying path 106. The document passes over the slit portion 108 and is then discharged to the document discharging table 7. When the document D passes over the slit portion 108 on the conveying path 108, a read surface of the document D comes into contact with a surface of the contact glass 108a.

When the document is read using the ADF 104, the first carriage 18 in the image reading apparatus 100 main body is moved to a read position on the contact glass 108a where the image is read. Thus, the image on a surface of the document conveyed by the ADF 104 along the conveying path 106a at a specified speed is read by the 4-line CCD sensor 1 via the optical system including the first mirror 16, the second mirror 22, the third mirror 24, and the image forming lens 26.

Now, description will be given of a focal position with respect to the read surface of a document according to the image reading apparatus 100.

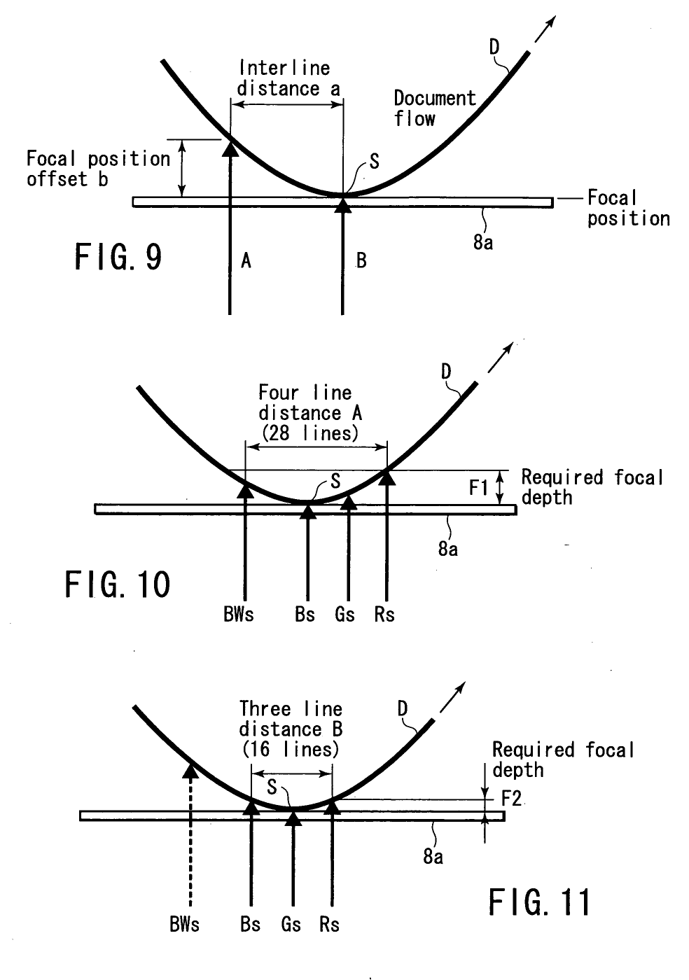

FIG. 9 is a diagram showing the offset between a focal position based on a first scan position A and a focal position based on a second scan position located at a distance a from the first scan position.

With the ADF 104, the read surface of the document D conveyed along the conveying path 106a contacts with the surface of the contact glass 108a in the slit portion 108. The read surface of the document and the surface of the contact glass 108a contact with each other at almost one point in a direction in which the document is conveyed (on one line in a main scanning direction). In the description of the present embodiment, the contact point (the line in the main scanning direction on which the contact occurs) between the read surface of the document D and the surface of the contact glass 108a is fixed.

In the example shown in FIG. 9, the read surface of the document D comes into contact with the surface of the contact glass 108a at the second scan position B. In this case, the read surface of the document D is at a distance b from the surface of the contact glass 108a at the first scan position A. That is, if the focal position is on the surface of the contact glass 108a, then at the first scan position A, it is offset by the distance b compared to the second scan position B. In this case, if a focal depth is less than b, an image read at the first scan position A is likely to be out of focus.

With the ADF 104, the document D is conveyed so that its read surface is concave with respect to the surface of the contact glass 108a. The read surface of the document D comes into contact with the surface of the contact glass 108a at the contact point S. That is, to obtain a favorable image in a process of reading a document using the ADF 104, it is necessary to execute read scanning with the scan position fixed as close to the contact point S as possible, where the surface of the contact glass 108a and the read surface of the document D contact with each other.

Now, description will be given of the relationship between the scan position of each of the line sensors R, G, B, and BW and the read surface of the document D upon passage over the slit portion 108. In the following description, the scan position of the red line sensor R is defined as Rs, the scan position of the green line sensor G is defined as Gs, the scan position of the blue line sensor B is defined as Bs, and the scan position of the black and white line sensor BW is defined as BWs.

FIG. 10 is a diagram showing focal positions based on the scan positions Rs, Gs, Bs, and BWs if the scan position Bs is set at the contact point S.

In the example shown in FIG. 10, the scan position Bs, which is the substantial center of the scan positions Rs, Gs, Bs, and BWs of the four line sensors, provides the optimum focal position. The position of the contact point S, which corresponds to the optimum focal position, will be referred to as a focused position. In the example shown in FIG. 10, for the scan positions Rs, Gs, and BWs, the offset from the optimum focal position increases in order of Gs, BWs and Rs. In other words, a scan position located further from the focused position results in a larger focal offset. For example, in the example shown in FIG. 10, at least a focal depth F1 is required to allow the red line sensor R to read correct data.

Specifically, the required focal depth F1 increases when the first carriage 18 is set to constantly start reading at a predetermined position if an image is read using the ADF 104. Consequently, if an image is read from a document conveyed by the ADF 104 at the fixed read position regardless of whether the color or monochromatic reading is carried out, then the image obtained using the 4-line CCD sensor may be degraded.

Now, description will be given of the relationship between each of the scan positions Rs, Gs, Bs, and BWs and the read surface of the document D in the color read mode.

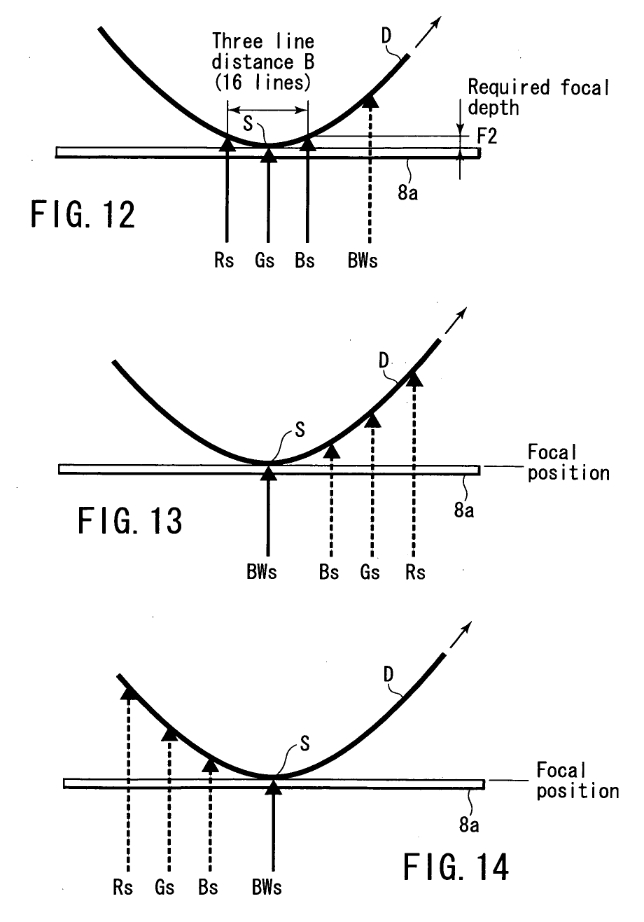

FIGS. 11 and 12 are diagrams showing the relationship between each of the scan positions Rs, Gs, Bs, and BWs and the read surface of the document D in the color read mode. FIG. 11 shows an example in which the scan positions are arranged in order of Rs, Gs, Bs, and BWs. FIG. 12 shows an example in which the scan positions are arranged in order of BWs, Bs, Gs, and Rs.

In the examples shown in FIGS. 11 and 12, the scan position Gs, which is the center of the scan positions Rs, Gs, and Bs of the line sensors for colors R, G, and B, is set as the contact point S. In this case, compared to the scan position Gs, which corresponds to the focused position, the scan positions Rs and Bs provide a focal position at a distance F2. That is, the line sensors for colors R, G, and B have focal depths equal to or less than F2. The focal depth F2 is smaller than the focal depth F1, shown in FIG. 10 and corresponds to the smallest focal depth of the color line sensor, composed of the three line sensors R, G, and B.

Specifically, in the color read mode, as the color read position, the read position of the first carriage 18 is determined so that the contact point S coincides with the center of the scan position of the color line sensor, composed of the plurality of line sensors. Accordingly, if a color image is read using a 4-line CCD color sensor such as the one shown in FIG. 1, the read position of the first carriage 18 which corresponds to the color read position is set so that the scan position Gs of the green line sensor G, located in the center, coincides with the contact point S, because the color line sensor is composed of the three line sensors R, G, and B.

The color read position is preset on the basis of, for example, coordinate values with respect to the predetermined standby position of the first carriage 18. The coordinate values of the color read position with respect to the standby position of the first carriage 18 are pre-stored in the memory such as the ROM 41. Thus, if the color read mode is selected, the CPU 40 reads the coordinate of the color read position from the ROM 41. The CPU 40 then moves the first carrier to the color read position.

Now, description will be given of the relationship between each of the scan positions Rs, Gs, Bs, and BWs and the read surface of the document D in the monochromatic read mode.

FIGS. 13 and 14 are diagrams showing the relationship between each of the scan positions Rs, Gs, Bs, and BWs and the read surface of the document D in the monochromatic read mode. FIG. 13 shows an example in which the scan positions of the four line sensors are arranged in order of Rs, Gs, Bs, and BWs. FIG. 14 shows an example in which the scan positions of the four line sensors are arranged in order of BWs, Bs, Gs, and Rs.

As shown in FIGS. 13 and 14, the scan position BWs of the monochromatic line sensor BW corresponds to the contact point (focused position) S. Specifically, in the monochromatic read mode, as the monochromatic read position, the position of the first carriage 18 is determined so that the center of the scan positions of the monochromatic line sensor coincides with the contact point S. Accordingly, if a 4-line CCD color sensor such as the one shown in FIG. 1 is used, the read position of the first carriage 18 which corresponds to the monochromatic read position is set so that the scan position of the black and white line sensor BW coincides with the contact point S, because the monochromatic line sensor is composed only of the black and white line sensor BW.

The monochromatic read position is preset on the basis of, for example, coordinate values with respect to the predetermined standby position of the first carriage 18. The coordinate values of the monochromatic read position with respect to the standby position of the first carriage 18 are pre-stored in the memory such as the ROM 41. Thus, if the monochromatic read mode is selected, the CPU 40 reads the coordinate of the monochromatic read position from the ROM 41. The CPU 40 then moves the first carrier to the monochromatic read position.

Now, description will be given of an operation of reading a document image using the ADF 104 as the second embodiment.

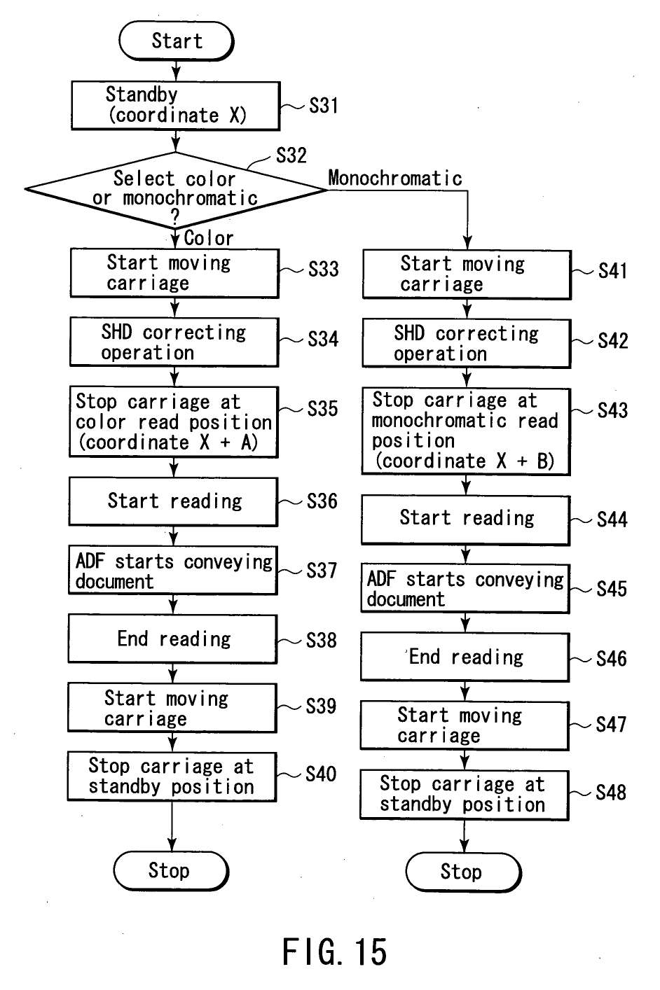

FIG. 15 is a flow chart illustrating an operation of reading an image from a document set in the ADF 104, provided as the second embodiment.

First, the user places a document on the document feeding table 105 of the ADF 104 and uses the operation section 60 to instruct on reading of a document image. On this occasion, the user selects the document read mode, that is, whether to read the image from the document in multiple colors or monochromatically. When the user instructs on the start of reading, the operation section 60 supplies the CPU 40 with a signal requesting the start of reading as well as information indicative of the document read mode.

Upon receiving the read start request from the operation section 60, the CPU 40 checks whether or not the first carriage 18 is present at the standby position. Upon confirming that the first carriage 40 is at the standby position, the CPU 40 sets the coordinate indicative of the position of the first carriage 18, at a coordinate value X for the standby position (step S31).

If the coordinate of the first carriage 18 is defined as X, the CPU 40 selects whether the document is to be read in the color read mode or the monochromatic read mode, on the basis of the information from the operation section 60, which is indicative of the read mode (step S32).

Then, upon selecting the color read mode as the document read mode (step S32, color), the CPU 40 starts moving the first carriage 18, which is now lying at the standby position (step S33).

After stating to move the first carriage 18, the CPU 40 first uses the color line sensor (red line sensor R, green line sensor G, and blue line sensor B) to read an image from a white reference plate (not shown). The CPU 40 then executes shading corrections on output signals (R, G, and B signals) from the line sensors R, G, and B (step S34).

When the first carriage 18 reaches the color read position after reading the white reference plate, that is, when the coordinate indicative of the position of the first carriage 18 becomes equal to that of the color read position (X+A: A denotes the distance from the standby position to the read position), the CPU 40 stops the first carriage 18 (step S35). The coordinate of the color read position is preset in the ROM 41 or the like so that the center (scan position Gs) of the scan positions Rs, Gs, and Bs of the line sensors for colors R, G, and B coincides with the contact point S as shown in FIG. 11 or 12.

When the first carriage 18 is stopped, the CPU 40 starts loading the R, G, and B signals from the line sensors for colors R, G, and B (step S36). At this time, the CPU 40 requests that the documents start to be conveyed to the ADF 104. In response to this conveyance start request, the ADF 104 causes the conveying section 106 to start conveying one of the documents on the document feeding table 105 (step S37). Thus, the line sensors for colors R, G, and B read, in multiple colors, the image from the read surface of the document D conveyed along the conveying path 106a.

The CPU 40 continues to read color images as described above until the documents on the document feeding table 105 are exhausted. That is, if no documents are left on the document feeding table 105 of the ADF 104, the CPU 40 determines that the reading of the document images in the color read mode has been finished (step S38). Upon determining that the reading of the document images in multiple colors has been finished, the CPU 40 starts moving the first carriage 18 to the standby position (step S39). Once the first carriage moves to the standby position, that is, once the coordinate indicative of the position of the first carriage 18 becomes X, the CPU 40 ends moving the first carriage 18 and thus the operation of reading the images in the color read mode (step S40).

Upon selecting the monochromatic color read mode as the document read mode in step S32 (step S32, monochrome), the CPU 40 starts moving the first carriage 18, which is now lying at the standby position (step S41). After stating to move the first carriage 18, the CPU 40 first uses the monochromatic line sensor (black and white line sensor BW) to read the image from the white reference plate (not shown). The CPU 40 then executes shading corrections on the BW signal from the black and white line sensor BW (step S42).

When the first carriage 18 reaches the monochromatic read position after reading the white reference plate, that is, when the coordinate indicative of the position of the first carriage 18 becomes equal to that of the monochromatic read position (X+B: B denotes the distance from the standby position to the read position), the CPU 40 stops the first carriage 18 (step S43). The coordinate of the monochromatic read position is preset in the ROM 41 or the like so that the scan position BWs of the monochromatic line sensor BW.

When the first carriage 18 is stopped, the CPU 40 starts loading the BW signal from the monochromatic line sensor BW (step S44). At this time, the CPU 40 requests that the documents start to be conveyed to the ADF 104. In response to this conveyance start request, the ADF 104 causes the conveying section 106 to start conveying one of the documents on the document feeding table 105 (step S45). Thus, the monochromatic line sensor BW monochromatically reads the image from the read surface of the document D conveyed along the conveying path 106a.

The CPU 40 continues to read monochromatic images as described above until the documents on the document feeding table 105 are exhausted. That is, if no documents are left on the document feeding table 105 of the ADF 104, the CPU 40 determines that the reading of the document images in the monochromatic read mode has been finished (step S46). Upon determining that the reading of the document images in multiple colors has been finished, the CPU 40 starts moving the first carriage 18 to the standby position (step S47). Once the first carriage moves to the standby position, that is, once the coordinate indicative of the position of the first carriage 18 becomes X, the CPU 40 ends moving the first carriage 18 and thus the operation of reading the images in the monochromatic read mode (step S48).

As described above, according to the second embodiment, in the color read mode, the first carriage is moved to the color read position, where the color line sensor reads the image from the document conveyed by the ADF. In the monochromatic read mode, the first carriage is moved to the monochromatic read position, where the color line sensor reads the image from the document conveyed by the ADF.

Thus, according to the second embodiment, if a document image is read using the ADF, the optimum scan position can be set for each line sensor either in the color mode or in the monochromatic read mode. This prevents the read image from being degraded. Therefore, a high quality read image can be provided.

Now, a third embodiment will be described.

The third embodiment is a variation of the second embodiment. That is, an image reading apparatus according to the third embodiment is configured similarly to the image reading apparatus described in the second embodiment. In the description below of the third embodiment, it is assumed that the image reading apparatus 100 according to the third embodiment is configured as shown in FIG. 8 and that the control system of the image reading apparatus 100 is configured as shown in FIG. 3.

First, description will be given of the sensitivity characteristics of the line sensors (R, G, B, and BW) constituting the 4-line CCD sensor 1, as a background for implementing the image reading apparatus according to the third embodiment.

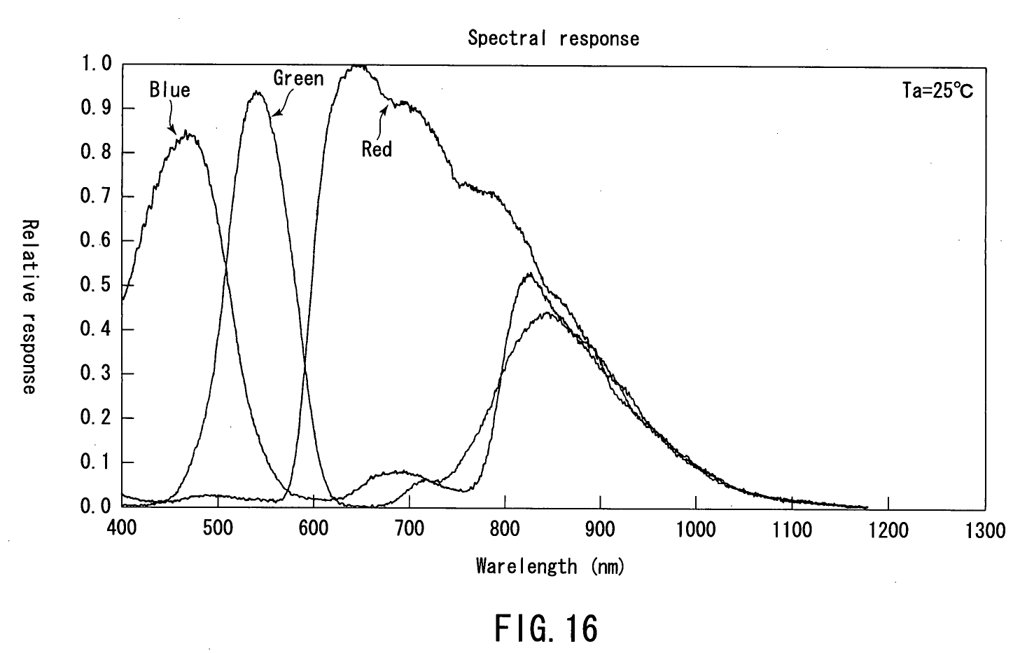

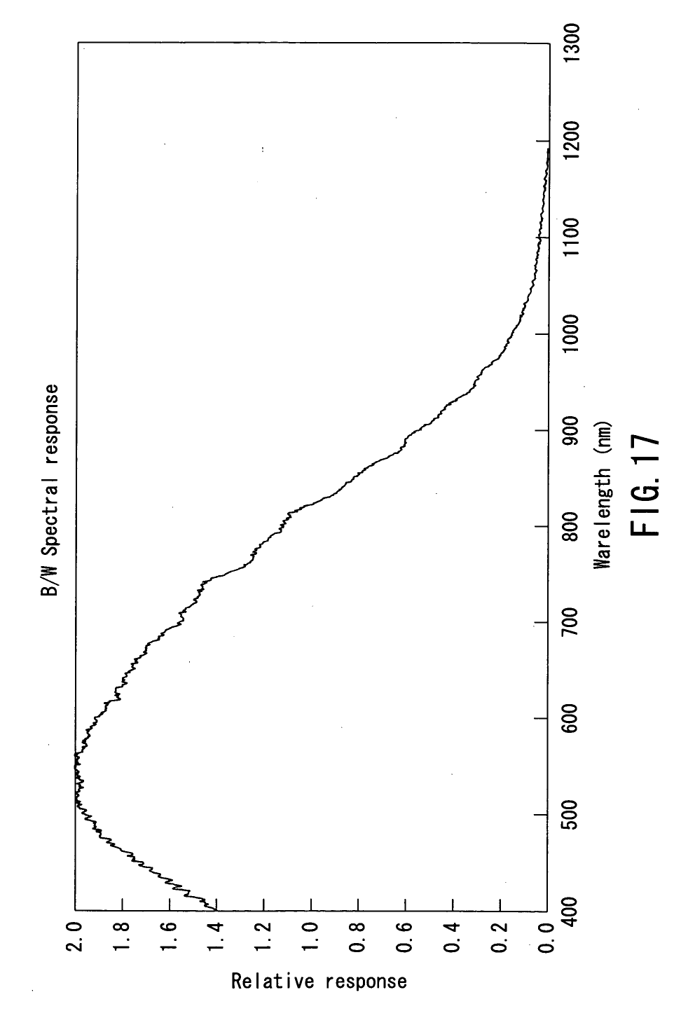

FIG. 16 is a graph showing an example of the sensitivities of the red line sensor R, green line sensor G, and blue line sensor B to incident light. FIG. 17 is a graph showing an example of the sensitivity of the black and white line sensor BW to incident light.

In the example shown in FIG. 16, within the range of visible light (400 to 800 nm), the sensitivity of the red line sensor R to incident light (red light) of about 600 to 800 nm is “1” at maximum. In contrast, the sensitivity of the green line sensor G to incident light (green light) of about 500 to 600 nm is “0.9 to 0.95” at maximum. The sensitivity of the blue line sensor B to incident light (blue light) of about 400 to 500 nm is “0.8 to 0.85” at maximum.

In other words, in the example shown in FIG. 16, if the red line sensor is defined to have a sensitivity of “1”, the green light sensor G has a sensitivity of “0.9 to 0.95” and the blue light sensor G has a sensitivity of “0.8 to 0.85”.

Furthermore, as is apparent from a comparison of FIG. 16 with FIG. 17, the black and white line sensor BW has a sensitivity of “2” at maximum. That is, the black and white line sensor BW has a sensitivity twice that of the red line sensor R.

This is because the red line sensor R, the green line sensor G, and the blue line sensor B are composed of CCD line sensors including a red, green, and blue filters, respectively, whereas the black and white line sensor BW is composed of a CCD line sensor not including any filters. That is, the line sensors for colors R, G, and B with the respective color filters have a sensitivity half that of the black and white line sensor BW without any color filters.

As described above, in the 4-line CCD sensor, the four line sensors constituting the 4-line CCD sensor are characterized in that their sensitivity increases in order of the black and white line sensor BW, the red line sensor R, the green line sensor G, and the blue line sensor B.

Furthermore, the exposure lamp 14 is provided with fluorescent agents so that the respective color lights of emitted light have an equal intensity. However, the fluorescent agent used to emit blue light may be less durable than the fluorescent agents used to generate other colors. Specifically, the blue light may tend to become fainter owing to secular changes even though the fluorescent agents are compounded so that the respective color lights have an equal intensity or in accordance with the sensitivities of the respective sensors. As a result, in the output of the 4-line CCD sensor, the output of the blue line sensor B may be lower than the output of the other line sensors because of secular changes.

In view of these circumstances, those of the plurality of line sensors constituting the 4-line CCD sensor 1 preferably carry out reading under better conditions than the other line sensors. Specifically, the quality of the entire read image can be improved by allowing line sensors having low sensitivities to carry out reading under as good conditions as possible.

Preferably, line sensors reading color lights that tend to become fainter owing to secular changes also carry out reading under better conditions than the other line sensors. Specifically, read images unlikely to be degraded by secular changes can be obtained by allowing line sensors reading color lights that tend to become fainter owing to secular changes to carry out reading under as good conditions as possible.

Now, description will be given of the relationship between the scan position of each of the line sensors R, G, B, and BW and the read surface of the document D upon passage over the slit portion 108.

In the following description, the scan position of the red line sensor R is defined as Rs, the scan position of the green line sensor G is defined as Gs, the scan position of the blue line sensor B is defined as Bs, and the scan position of the black and white line sensor BW is defined as BWs. The focus of each line sensor is set on the contact surface. The position of the contact point S where the optimum focal position is established (the position where the read surface of the document comes into contact with the contact surface) is referred to as the focused point.

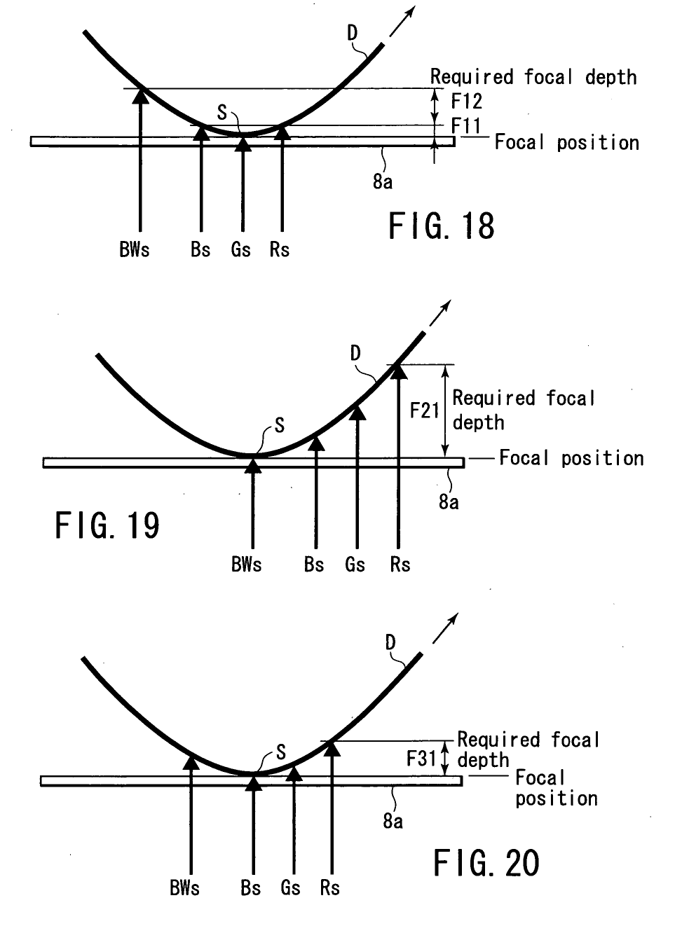

FIGS. 18, 19, and 20 show examples of the relationship between the scan positions Rs, Gs, Bs, and BWs of the line sensors R, G, B, and BW, which constitute the 4-line CCD sensor, and the read surface of the document D.

FIG. 18 is a diagram showing the relationship between the scan positions Rs, Gs, Bs, and BWs of the line sensors R, G, B, and BW and the focal depth which relationship is observed if the green line sensor G is aligned with the focused position.

In the example shown in FIG. 18, the scan position Gs, which is the center of the scan positions Rs, Gs, and Bs of the line sensors for colors R, G, and B, corresponds to the focused position (contact position S). In this case, in contrast to the scan position Gs, which corresponds to the focused position, at the scan positions Rs and Bs, the red line sensor R and the blue line sensor B require a focal depth F11 as shown in FIG. 18.

For the 4-line CCD sensor configured as shown in FIG. 1, the focal depth F11 is a distance equal to 8 lines with respect to the curvature of the read surface of the document. This is the smallest focal depth of the three line sensors R, G, and B, which constitute the color line sensor. Thus, if a document image is read in multiple colors (the document image is read using the line sensors R, G, and B), it can be favorably read if the line sensors for colors R, G, and B have at least the focal depth F11.

However, as shown in FIG. 18, at the scan position BWs, the black and white line sensor BW requires a focal depth F12. The focal depth F12 is larger than the focal depth F11, and in the 4-line CCD sensor configured as shown in FIG. 1, is a distance equal to 20 lines with respect to the curvature of the document.

Accordingly, if a monochromatic image is read (the document image is read using the black and white line sensor BW), it can be favorably read provided that the black and white line sensor has at least the focal depth F12. However, as described above, because of the magnitude of the focal depth F12, the scan position shown in FIG. 18 is disadvantageous in using the black and white line sensor to read the document image.

FIG. 19 is a diagram showing the relationship between the scan positions Rs, Gs, Bs, and BWs of the line sensors R, G, B, and BW and the focal depth which relationship is observed if the scan position BWs of the black and white line sensor BW is aligned with the focused position.

In the example shown in FIG. 19, the scan position BWs of the monochromatic line sensor BW corresponds to the focused position (contact position S). In this case, for the monochromatic line sensor BW, the read surface of the document coincides with the focal position. Thus, if a document image is monochromatically read (the document image is read using the black and white line sensor BW), it can be favorably read if the black and white line sensor BW has a focal depth of zero.

However, as shown in FIG. 19, for the scan positions Rs, Gs, and Bs of the line sensors for colors R, G, and B, the focal depth increases in order of Rs, Gs, and Bs. For example, the scan position Rs, which requires the largest focal depth, requires at least a focal depth F21. In this case, the red line sensor R cannot read a favorable image (image data on a red component) unless the red line sensor R is set for at least the focal depth F21. Similarly, the focal depths of the green sensor G and blue line sensor B must be set in accordance with the scan positions Gs and Bs, respectively. Thus, the scan position shown in FIG. 19 is disadvantageous in using the line sensors for colors R, G, and B to read the document image in multiple colors.

FIG. 20 is a diagram showing focal positions based on the scan positions Rs, Gs, Bs, and BWs if the scan position Bs is aligned with the focused position.

In the example shown in FIG. 20, the scan position Bs, which is the substantial center of the scan positions Rs, Gs, Bs, and BWs of the four line sensors, corresponds to the focused position. In the example shown in FIG. 20, for the scan positions Rs, Gs, and BWs, the offset from the optimum focal position increases in order of Gs, BWs, and Rs with respect to the scan position Bs. In other words, a scan position located further from the focused position results in a larger focal offset. For example, in the example shown in FIG. 20, at least a focal depth F31 is required to allow the red line sensor R to read correct data at the scan position Rs, located furthest from the focused position.

However, the focal depth F31, shown in FIG. 20, is smaller than the focal depths F11 and F21, described above. Accordingly, the focal depth F31 can be more advantageously set as a focal depth permitted by the line sensors. On the other hand, in view of the driving control of the first carriage 18, if an image is read using the ADF 104, the same read position is preferably used either in the color read mode or in the monochromatic read mode. In this case, with the image reading apparatus 100 using the 4-line CCD sensor 1, the read position used when the document image is read using the ADF 104 must be set so as to enable a high quality image to be read either in the color read mode or in the monochromatic read mode.

Description will be given below of the setting of the read position with respect to the document conveyed by the ADF in the image reading apparatus that uses the photoelectric converting unit composed of the monochromatic line sensor and the color line sensor.

First, with the image reading apparatus that uses the line sensor having the monochromatic line sensor and the color line sensor, to use a single fixed position to allow all the line sensors to have reduced focal depths, it is desirable to make settings such that the central position of all the line sensors corresponds to the focused position. However, since the line sensors have different sensitivity characteristics or the like, the central position of the line sensors does not always correspond to the optimum position.

Accordingly, in the third embodiment, the optimum read position used to read a document image using the ADF is set on the basis of the sensitivity characteristics, arrangement, and focal depths of the line sensors.

That is, as described above, in view of the sensitivities of the line sensors, less sensitive line sensors can read a high quality image by minimizing the distance to the read surface. More sensitive line sensors can read a high quality image provided that its distance to the read surface is equal to or less than the focal depth even if it is larger than those of the other line sensors.

If for example, the line sensors (R, G, B, and BW) constituting the 4-line CCD sensor 1 such as the one shown in FIG. 1 have sensitivity characteristics such as those shown in FIGS. 16 and 17, then settings are made so that the scan position Bs of the blue line sensor, which has the lowest sensitivity, coincides with the focused position. This makes it possible to set a single read position in accordance with the sensitivity characteristics of the line sensors constituting the 4-line CCD sensor 1.

FIG. 20 shows an example of a set position used if the 4-line CCD sensor 1 shown in FIG. 1 has the sensitivity characteristics shown in FIGS. 16 and 17. For example, the focused position may be set between the blue line sensor B and the green line sensor G. Furthermore, even if the arrangement of the line sensors R, G, B, and BW of the 4-line CCD sensor is different from the one shown in FIG. 1, the optimum read position can be set on the basis of the arrangement and sensitivity characteristics of the line sensors.

Furthermore, if the exposure lamp 14 has a light emission characteristic such as the one described above, then the read position may be set taking it into consideration. For example, if the exposure lamp 14 is characterized in that a particular color light of the light emitted by the exposure lamp 14 may be degraded (may become fainter) by secular changes, that is, the particular color light becomes fainter owing to secular changes, then the scan position of the line sensor sensing this particular light is set close to the focused position. This is effective in allowing a high quality image to be read even if the particular color light becomes fainter owing to secular changes.

As described above, in the third embodiment, a single fixed optimum read position is set on the basis of the focal depths, arrangement, and sensitivity characteristics of the line sensors as well as the light emission characteristic of the exposure lamp. This enables the setting of a single read position where a high quality document image can be read either in the monochromatic read mode or in the color read mode. As a result, a document conveyed by the ADF can be read at the single read position either in the monochromatic read mode or in the color read mode. This makes it easy to control the carriage and others.

Furthermore, as described in the above example, if the blue line sensor B has a lower sensitivity than the other line sensors and blue light from the exposure lamp 14 is likely to become fainter owing to secular changes compared to the other color lights, then the scan position of the blue line sensor B is set closer to the focused position than those of the other line sensors. This enables a high quality document image to be read either in the monochromatic read mode or in the color read mode. It is also possible to set a single read position where high quality document images can be read over a long period in spite of secular changes.

Now, description will be given of an operation of reading a document image using the ADF 104 as the third embodiment.

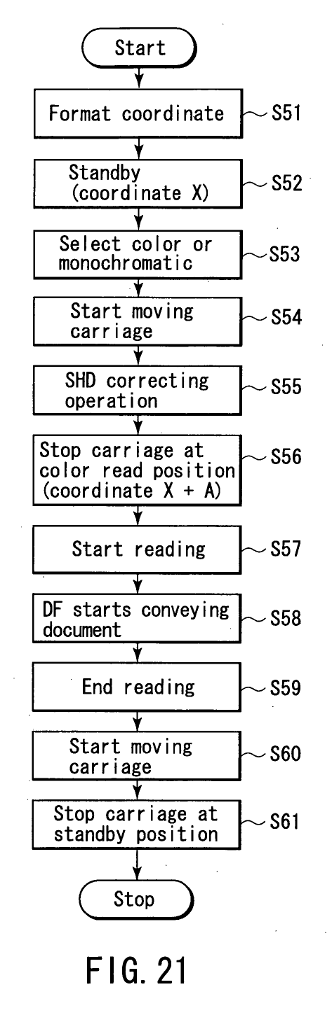

FIG. 21 is a flow chart illustrating an operation of reading an image from a document set in the ADF 104.

First, the user places a document on the document feeding table 105 of the ADF 104 and uses the operation section 60 to instruct on reading of a document image. On this occasion, the user selects the document read mode, that is, whether to read the image from the document in multiple colors or monochromatically. When the user instructs on the start of reading, the operation section 60 supplies the CPU 40 with a signal requesting the start of reading as well as information indicative of the document read mode.

Upon receiving the read start request from the operation section 60, the CPU 40 checks whether or not the first carriage 18 is present at the standby position. Upon confirming that the first carriage 40 is at the standby position, the CPU 40 sets the initialized coordinate indicative of the position of the first carriage 18, in the RAM 42 (step S51). Then, the CPU 40 sets the coordinate at the value X for the standby position (step S52). If the coordinate of the first carriage 18 is defined as X, the CPU 40 selects whether the document is to be read in the color read mode or the monochromatic read mode, on the basis of the information from the operation section, which is indicative of the read mode (step S53).

Then, upon selecting the color read mode as the document read mode (step S53), the CPU 40 starts moving the first carriage 18, which is now lying at the standby position (step S54). The CPU 40 uses the color line sensor (red line sensor R, green line sensor G, and blue line sensor B) to read the image from the white reference plate (not shown). The CPU 40 then executes shading corrections on output signals (R, G, and B signals) from the line sensors R, G, and B (step S55).

When the first carriage 18 reaches a predetermined read position after reading the white reference plate, that is, when the coordinate indicative of the position of the first carriage 18 becomes equal to that of the predetermined read position (X+A: A denotes the distance from the standby position to the predetermined read position), the CPU 40 stops the first carriage 18 (step S56).

The predetermined read position is preset on the sensitivities, arrangement, and focal depths of the line sensors, and the like as described above. For example, the predetermined read position allows the 4-line CCD sensor to be positioned as shown in FIG. 20. Furthermore, the coordinate A, which is indicative of the distance from the standby position to the predetermined read position, is pre-stored in the ROM 41 or the like. The coordinate A is pre-stored in the ROM 41 or the like so as to, for example, set the scan position Bs of the blue line sensor B as the contact point S as shown in FIG. 20.

When the first carriage 18 is stopped, the CPU 40 starts loading the R, G, and B signals from the line sensors for colors R, G, and B (step S57). At this time, the CPU 40 requests that the documents start to be conveyed to the ADF 104. In response to this conveyance start request, the ADF 104 causes the conveying section 106 to start conveying one of the documents on the document feeding table 105 (step S58). Thus, the line sensors for colors R, G, and B read, in multiple colors, the image from the read surface of the document D conveyed along the conveying path 106a.

Likewise, upon selecting the monochromatic color read mode as the document read mode (step S53), the CPU 40 starts moving the first carriage 18, which is now lying at the standby position (step S54). The CPU 40 uses the monochromatic line sensor (black and white line sensor BW) to read the image from the white reference plate (not shown). The CPU 40 then executes shading corrections on the BW signal from the black and white line sensor BW (step S55).

When the first carriage 18 reaches the predetermined read position after reading the white reference plate, that is, when the coordinate indicative of the position of the first carriage 18 becomes equal to that of the predetermined read position (X+A), the CPU 40 stops the first carriage 18 (step S56). The read position in this case is the same as that in the color read mode and allows the 4-line CCD sensor to be positioned as shown in FIG. 20.

When the first carriage 18 is stopped, the CPU 40 starts loading the BW signal from the monochromatic line sensor BW, which constitutes the monochromatic line sensor (step S57). At this time, the CPU 40 requests that the documents start to be conveyed to the ADF 104. In response to this conveyance start request, the ADF 104 causes the conveying section 106 to start conveying one of the documents on the document feeding table 105 (step S58). Thus, the monochromatic line sensor BW monochromatically reads the image from the read surface of the document D conveyed along the conveying path 106a.

The CPU 40 continues to read color or monochromatic images as described above until the documents on the document feeding table 105 are exhausted. That is, if no documents are left on the document feeding table 105 of the ADF 104, the CPU 40 determines that the reading of the document images in the color read mode has been finished (step S59). Upon determining that the reading of the document images has been finished, the CPU 40 starts moving the first carriage 18 to the standby position (step S60). Once the first carriage moves to the standby position, that is, once the coordinate indicative of the position of the first carriage 18 becomes X, the CPU 40 ends moving the first carriage 18 and thus the operation of reading the images (step S61).

As described above, in the third embodiment, a single read position is set on the basis of the sensitivity characteristics, focal depths, or arrangement of the line sensors. Accordingly, either in the color read mode or in the monochromatic read mode, the first carriage can be moved to the predetermined read position, where the image can be read from the document conveyed by the ADF using the color line sensor or the monochromatic line sensor.

Consequently, according to the third embodiment, the document can be read at the single read position either in the color read mode or in the monochromatic read mode. This prevents the read image from being degraded. Therefore, a high quality read image can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image reading apparatus which reads an image from a document placed on a document glass, in multiple colors or monochromatically, the apparatus comprising:
a photoelectric converting unit composed of a color line sensor and a monochromatic line sensor;
a scanning section in which an optical system guiding light from the document on the document glass to the photoelectric converting unit is mounted;
a driving mechanism which moves the scanning section in a sub-scanning direction relative to the document on the document glass; and
a control section which uses the color line sensor to start loading image data if the image is read, in multiple colors, from the document placed on the document glass and when a scan position of the scanning section moved by the driving mechanism in the sub-scanning direction reaches a color read start position, and which uses the monochromatic line sensor to start loading image data if the image is read monochromatically from the document placed on the document glass and when the scan position of the scanning section moved by the driving mechanism in the sub-scanning direction reaches a monochromatic read start position different from the color read start position.

2. The image reading apparatus according to claim 1, wherein the color read start position is determined on the basis of a relationship between the scan position of the scanning section and a position of the color line sensor with respect to the document glass, and
the monochromatic read start position is determined on the basis of a relationship between the scan position of the scanning section and a position of the monochromatic line sensor with respect to the document glass.

3. The image reading apparatus according to claim 1, wherein if the image is read, in multiple colors, from the document placed on the document glass, the control section loads data from the color line sensor after the scan position of the scanning section moved by the driving mechanism in the sub-scanning direction has reached the color read start position and before a color read end position is reached which is based on the color read start position and a size of the document in the sub-scanning direction, and
if the image is monochromatically read from the document placed on the document glass, the control section loads data from the monochromatic line sensor after the scan position of the scanning section moved by the driving mechanism in the sub-scanning direction has reached the monochromatic read start position different from the color read start position and before a monochromatic read end position is reached which is based on the monochromatic read start position and a size of the document in the sub-scanning direction.

4. The image reading apparatus according to claim 1, wherein the driving mechanism is composed of a stepping motor which is driven in response to a driving clock provided by the control section, and
if the image is read, in multiple colors, from the document placed on the document glass, the control section starts loading data from the color line sensor when the driving mechanism causes the scanning section to move a distance corresponding to a color read start clock, and
if the image is monochromatically read from the document placed on the document glass, the control section starts loading data from the monochromatic line sensor when the driving mechanism causes the scanning section to move a distance corresponding to a monochromatic read start clock different from the color read start clock.

5. The image reading apparatus according to claim 4, wherein the color read start clock is determined on the basis of a speed at which the scanning section moves and a distance from a position where the scanning section starts to move to the color read start position, and
the monochromatic read start clock is determined on the basis of the speed at which the scanning section moves and a distance from the position where the scanning section starts to move to the monochromatic read start position.

6. The image reading apparatus according to claim 1, wherein in the photoelectric converting unit, the color line sensor and the monochromatic line sensor are arranged in the sub-scanning direction with a predetermined distance between them, and
if the image is read, in multiple colors, from the document placed on the document glass, the control section starts loading data from the color line sensor when the scanning section moved by the driving mechanism in the sub-scanning direction reaches a predetermined read start position, and
if the image is monochromatically read from the document placed on the document glass, the control section starts loading data from the monochromatic line sensors when the scanning section moved by the driving mechanism in the sub-scanning direction moves a distance equal to the distance between the color line sensor and the monochromatic line sensor, from the predetermined read start position.

7. An image reading apparatus which reads an image from a document in multiple colors or monochromatically, the apparatus comprising:
a document feeding section that conveys the document placed on a document feeding table;
a photoelectric converting unit composed of a color line sensor and a monochromatic line sensor;
a scanning section in which an optical system guiding light from the document conveyed by the document feeding section to the photoelectric converting unit is mounted;
a driving mechanism which moves the scanning section; and
a control section which uses the driving mechanism to move the scanning section from a predetermined standby position to a color read position if the image is read from the document conveyed by the document feeding section in a color read mode in which the color line sensor reads the image, the control section using the driving mechanism to move the scanning section from the predetermined standby position to a monochromatic read position if the image is read from the document conveyed by the document feeding section in a monochromatic read mode in which the monochromatic line sensor reads the image.

8. The image reading apparatus according to claim 7, wherein the color read position is set by aligning a central position of the scan position of the color line sensor with a focused position, and
the monochromatic read position is set by aligning a central position of the scan position of the monochromatic line sensor with the focused position.

9. The image reading apparatus according to claim 7, further comprising a memory which stores a first coordinate indicative of a distance from the standby position of the scanning section to the color read position and a second coordinate indicative of a distance from the standby position of the scanning section to the monochromatic read position, and
if the image is read from the document conveyed by the document feeding section, in the color read mode, the control section reads the first coordinate stored in the memory and then causes the driving mechanism to move the scanning section a distance equal to the first coordinate from the standby position, and then the scanning section reads, in multiple colors, the image from a read surface of the document conveyed by the document feeding section, and
if the image is monochromatically read from the document conveyed by the document feeding section, the control section reads the second coordinate stored in the memory and then causes the driving mechanism to move the scanning section a distance equal to the second coordinate from the standby position, and then the scanning section monochromatically reads the image from the read surface of the document conveyed by the document feeding section.

10. The image reading apparatus according to claim 7, wherein the color line sensor is composed of a plurality of line sensors, and
the color read position is set so that at the scan position of each of the line sensors constituting the color line sensor, a focal depth to the read surface of the document conveyed by the document feeding section is within a permissible range.

11. The image reading apparatus according to claim 7, wherein the color line sensor is composed of a plurality of line sensors, and
the color read position is set so that at the scan position of each of the line sensors constituting the color line sensor, a focal depth to the read surface of the document conveyed by the document feeding section is smallest.

12. The image reading apparatus according to claim 7, wherein the photoelectric converting unit is composed three line sensors for three primary colors arranged at predetermined intervals and a black and white line sensor,
the color read position is where a scan position of a central one of the three line sensors for the three primary colors coincides with the focused position, and
the monochromatic read position is where a scan position of the black and white line sensor coincides with the focused position.

13. An image reading apparatus which reads an image from a document in multiple colors or monochromatically, the apparatus comprising:
a document feeding section that conveys the document placed on a document feeding table;
a photoelectric converting unit composed of a color line sensor and a monochromatic line sensor;
a scanning section in which an optical system guiding light from a read surface of the document conveyed from the document feeding section to each line sensor of the photoelectric converting unit is mounted;
a driving mechanism which moves the scanning section; and
a control section which uses the driving mechanism to move the scanning section from a predetermined standby position to a read position set on the basis of a location of each line sensor with respect to the read surface of the document conveyed by the document feeding section as well as a sensitivity of each line sensor if the image is read from the document conveyed by the document feeding section, in multiple colors or monochromatically.

14. The image reading apparatus according to claim 13, wherein the read position is set so that all the line sensors constituting the photoelectric converting unit are positioned at or below the focal depth from the read surface of the document conveyed by the document feeding section and so that one of the plurality of line sensors which has the lowest sensitivity is located closest to the focused position.

15. The image reading apparatus according to claim 14, wherein the read position is further set so that the plurality of line sensors constituting the photoelectric converting unit other than the one having the lowest sensitivity are arranged successively further from the focused position in order of increasing sensitivity.

16. The image reading apparatus according to claim 13, wherein the photoelectric converting unit is composed of a monochromatic line sensor having the highest sensitivity and a first, second, and line sensor the sensitivity of which increases in this order, and scan positions of the line sensors are arranged in order of the monochromatic line sensor, the third line sensor, the second line sensor, and the first line sensor relative to a direction in which the document feeding section conveys the document, and
the read position is set so that the scan position of the third line sensor coincides with the focused position with respect to the read surface of the document conveyed by the document feeding section.

17. The image reading apparatus according to claim 16, wherein the first line sensor is a red line sensor which photoelectrically converts a red component of incident light, the second line sensor is a green line sensor which photoelectrically converts a green component of incident light, and the third line sensor is a blue line sensor which photoelectrically converts a blue component of incident light, and
the read position is set so that the scan position of the blue line sensor coincides with the focused position with respect to the read surface of the document conveyed by the document feeding section.

18. A method of reading an image from a document placed on a document glass, in multiple colors or monochromatically, the method comprising:
causing a driving mechanism to move a scanning section in a sub-scanning direction relative to the document on the document glass, an optical system being mounted in the scanning section and guiding light from the document on the document glass to a photoelectric converting unit composed of a color line sensor and a monochromatic line sensor;
if the image is read, in multiple colors, from the document placed on the document glass, using the color line sensor to start loading image data when a scan position of the scanning section moved by the driving mechanism in the sub-scanning direction reaches a color read start position; and
if the image is read monochromatically from the document placed on the document glass, using the monochromatic line sensor to start loading image data when the scan position of the scanning section moved by the driving mechanism in the sub-scanning direction reaches a monochromatic read start position different from the color read start position.

19. The image reading method according to claim 18, wherein the color read start position is determined on the basis of a relationship between the scan position of the scanning section and a position of the color line sensor with respect to the document glass, and
the monochromatic read start position is determined on the basis of a relationship between the scan position of the scanning section and a position of the monochromatic line sensor with respect to the document glass.

20. The image reading apparatus according to claim 18, wherein if the image is read, in multiple colors, from the document placed on the document glass, data is loaded from the color line sensor after the scan position of the scanning section moved by the driving mechanism in the sub-scanning direction has reached the color read start position and before a color read end position is reached which is based on the color read start position and a size of the document in the sub-scanning direction, and
if the image is monochromatically read from the document placed on the document glass, data is loaded from the monochromatic line sensor after the scan position of the scanning section moved by the driving mechanism in the sub-scanning direction has reached the monochromatic read start position different from the color read start position and before a monochromatic read end position is reached which is based on the monochromatic read start position and a size of the document in the sub-scanning direction.

21. The image reading method according to claim 18, wherein the driving mechanism is composed of a stepping motor which is driven in response to a driving clock provided by the control section, and
if the image is read, in multiple colors, from the document placed on the document glass, data starts to be loaded from the color line sensor when the driving mechanism causes the scanning section to move a distance corresponding to a color read start clock, and
if the image is monochromatically read from the document placed on the document glass, data starts to be loaded from the monochromatic line sensor when the driving mechanism causes the scanning section to move a distance corresponding to a monochromatic read start clock different from the color read start clock.

22. The image reading method according to claim 21, wherein the color read start clock is determined on the basis of a speed at which the scanning section moves and a distance from a position where the scanning section starts to move to the color read start position, and
the monochromatic read start clock is determined on the basis of the speed at which the scanning section moves and a distance from the position where the scanning section starts to move to the monochromatic read start position.

23. The image reading method according to claim 18, wherein in the photoelectric converting unit, the color line sensor and the monochromatic line sensor are arranged in the sub-scanning direction with a predetermined distance between them, and
if the image is read, in multiple colors, from the document placed on the document glass, data starts to be loaded from the color line sensor when the scanning section moved by the driving mechanism in the sub-scanning direction reaches a predetermined read start position, and
if the image is monochromatically read from the document placed on the document glass, data starts to be loaded from the monochromatic line sensors when the scanning section moved by the driving mechanism in the sub-scanning direction moves a distance equal to the distance between the color line sensor and the monochromatic line sensor, from the predetermined read start position.

24. An image reading method used for an image reading apparatus having a document feeding section that conveys the document placed on a document feeding table, a photoelectric converting unit composed of a plurality of line sensors, a scanning section in which an optical system guiding light from the document conveyed by the document feeding section to the photoelectric converting unit is mounted, and a driving mechanism which moves the scanning section, the method comprising:
if the image is read from the document conveyed by the document feeding section in a color read mode, using the driving mechanism to move the scanning section from a predetermined standby position to a color read position and then reading the image from the document using the color line sensor included in the plurality of the line sensors constituting the photoelectric converting unit;
if the image is read from the document conveyed by the document feeding section in a monochromatic read mode, using the driving mechanism to move the scanning section from the predetermined standby position to a monochromatic read position and then reading the image from the document using the monochromatic line sensor included in the plurality of the line sensors constituting the photoelectric converting unit.

25. The image reading method according to claim 24, wherein the color read position is set by aligning a central position of the scan position of the color line sensor with a focused position, and
the monochromatic read position is set by aligning a central position of the scan position of the monochromatic line sensor with the focused position.

26. The image reading method according to claim 24, wherein the image reading apparatus has a memory which stores a first coordinate indicative of a distance from the standby position of the scanning section to the color read position and a second coordinate indicative of a distance from the standby position of the scanning section to the monochromatic read position, and
if the image is read from the document conveyed by the document feeding section, in the color read mode, the first coordinate stored in the memory is read, then the driving mechanism is caused to move the scanning section a distance equal to the first coordinate from the standby position, and subsequently the image is read, in multiple colors, from a read surface of the document conveyed by the document feeding section, and
if the image is monochromatically read from the document conveyed by the document feeding section, the second coordinate stored in the memory is read, then the driving mechanism is caused to move the scanning section a distance equal to the second coordinate from the standby position, and subsequently the image is monochromatically read from the read surface of the document conveyed by the document feeding section.

27. The image reading method according to claim 24, wherein the color line sensor is composed of a plurality of line sensors, and
the color read position is set so that at the scan position of each of the line sensors constituting the color line sensor, a focal depth to the read surface of the document conveyed by the document feeding section is within a permissible range.

28. The image reading method according to claim 24, wherein the color line sensor is composed of a plurality of line sensors, and
the color read position is set so that at the scan position of each of the line sensors constituting the color line sensor, a focal depth to the read surface of the document conveyed by the document feeding section is smallest.

29. The image reading method according to claim 24, wherein the photoelectric converting unit is composed three line sensors for three primary colors arranged at predetermined intervals and a black and white line sensor,
the color read position is where a scan position of a central one of the three line sensors for the three primary colors coincides with the focused position, and
the monochromatic read position is where a scan position of the black and white line sensor coincides with the focused position.

30. An image reading method used for an image reading apparatus having a document feeding section that conveys the document placed on a document feeding table, a photoelectric converting unit composed of a plurality of line sensors, a scanning section in which an optical system guiding light from the document conveyed by the document feeding section to each line sensor of the photoelectric converting unit is mounted, and a driving mechanism which moves the scanning section, the method comprising:
if the image is read from the document conveyed by the document feeding section, in multiple colors or monochromatically, the driving mechanism is used to move the scanning section from a predetermined standby position to a read position set on the basis of a location of each line sensor with respect to the read surface of the document conveyed by the document feeding section as well as a sensitivity of each line sensor, and then the image is read from the document using the color line sensor or monochromatic line sensor included in the plurality of line sensors constituting the photoelectric converting unit.

31. The image reading method according to claim 30, wherein the read position is set so that all the line sensors constituting the photoelectric converting unit are positioned at or below the focal depth from the read surface of the document conveyed by the document feeding section and so that one of the plurality of line sensors which has the lowest sensitivity is located closest to the focused position.

32. The image reading method according to claim 30, wherein the read position is further set so that the plurality of line sensors constituting the photoelectric converting unit other than the one having the lowest sensitivity are arranged successively further from the focused position in order of increasing sensitivity.

33. The image reading method according to claim 30, wherein the photoelectric converting unit is composed of a monochromatic line sensor having the highest sensitivity and a first, second, and line sensor the sensitivity of which increases in this order, and scan positions of the line sensors are arranged in order of the monochromatic line sensor, the third line sensor, the second line sensor, and the first line sensor relative to a direction in which the document feeding section conveys the document, and
the read position is set so that the scan position of the third line sensor coincides with the focused position with respect to the read surface of the document conveyed by the document feeding section.

34. The image reading method according to claim 33, wherein the first line sensor is a red line sensor which photoelectrically converts a red component of incident light, the second line sensor is a green line sensor which photoelectrically converts a green component of incident light, and the third line sensor is a blue line sensor which photoelectrically converts a blue component of incident light, and
the read position is set so that the scan position of the blue line sensor coincides with the focused position with respect to the read surface of the document conveyed by the document feeding section.
